(19) United States
(12) Patent Application Publication
(10) Pub. No.: US 2025/0389539 A1
(43) Pub. Date: Dec. 25, 2025

(54) SIGNAL PROCESSING DEVICE, SIGNAL PROCESSING METHOD, AND PROGRAM

(71) Applicant: SONY GROUP CORPORATION, TOKYO (JP)

(72) Inventors: YUYA YAMAGUCHI, TOKYO (JP); JUN GOMITA, TOKYO (JP)

(21) Appl. No.: 18/878,068

(22) PCT Filed: Jun. 20, 2023
(86) PCT No.: PCT/JP2023/022698

§ 371 Date: Dec. 22, 2024

(30) Foreign Application Priority Data
Jul. 5, 2022 (JP) 2022-108170

(51) Int. Cl. G01C 21/28; G03B 7/083; G03G 15/043; G06T 7/70

(52) U.S. Cl. CPC G01C 21/28; G03B 7/083; G03G 15/043; G06T 7/70

(57) ABSTRACT

The present technology relates to a signal processing device, a signal processing method, and a program enabling estimation of a self-position and posture with high accuracy. A signal processing device receives distance measurement information between a first ultra wide band (UWB) device arranged in a predetermined space and a second UWB device provided in a mobile object through UWB communication via the second UWB device, detects a feature point based on a light source from an image obtained from an imaging unit, and performs tracking between frames, in which the light source is arranged in the predetermined space and has a lighting timing controlled by a server on the basis of a time lag between the imaging unit provided in the mobile object and the server that controls the first UWB device. The signal processing device estimates a self-position and posture on the basis of a feature point of the light source, and corrects the self-position and posture on the basis of the distance measurement information. The present technology can be applied to a self-position and posture estimation system.

### TECHNICAL FIELD

The present technology relates to a signal processing device, a signal processing method, and a program, and more particularly, to a signal processing device, a signal processing method, and a program capable of estimating a self-position and posture with high accuracy.

### BACKGROUND ART

In services or applications such as augmented reality (AR) and virtual reality (VR), a self-position and posture of a head mount display (HMD) are estimated, and a video to be displayed is switched on the basis of the self-position and posture, whereby a virtual experience corresponding to a user's behavior is provided.

As a technique of estimating the self-position and posture, for example, there are two types of methods of OutSide-In and InSide-Out, and both have advantages and disadvantages.

In OutSide-In, a position and a posture of the HMD are not estimated on the HMD side, but an infrared camera arranged outside the HMD (that is, on an environmental side) captures reflected light from a retroreflective plate attached to the HMD, whereby the position and the posture of the HMD are estimated on the environment side.

In this OutSide-In, it is necessary to arrange an expensive camera in advance on the environment side. Therefore, not only the cost of the system increases, but also a wide directional angle and strong radiance are required for the camera on the environment side in order to obtain sufficient reflected light from a wide range, and large electric power is required as a region to be covered increases. In addition, there are large restrictions on an arrangement space, such as the need to arrange a physical camera.

Whereas, in InSide-Out, the HMD side estimates its own self-position and posture by continuing tracking of a feature point such as how the feature point shown in a camera image appears in the next frame, for example. This method is generally called vision simultaneous localization and mapping (SLAM).

Since InSide-Out has no restriction such as arranging a camera on the environment side, the cost is minimized, and the HMD can move in a relatively wide range. However, since the feature point needs to be continuously tracked, it is difficult to estimate the self-position and posture in an environment where a sufficient texture cannot be obtained, such as when illumination light rapidly changes.

Furthermore, in recent years, there have been proposed several methods for improving accuracy of estimating a self-position and posture of a mobile object by using ultra wide band (UWB) and using distance information between a UWB anchor and tag obtained from UWB. However, in the method using UWB, in order to maintain the accuracy, similarly to OutSide-In, it is necessary to install a large number of UWB anchors and tags on the environment side. In addition, since distance accuracy is an error of several tens of centimeters, in a case where application of the HMD and the like is assumed, only UWB is insufficient in terms of accuracy.

Whereas, a technique of combining UWB with vision SLAM (hereinafter, VSLAM) has been studied (see, for example, Non-Patent Document 1 and Non-Patent Document 2).

### CITATION LIST

### Non-Patent Document

Non-Patent Document 1: Thien Hoang Nguyen; Thien-Minh Nguyen; Lihua Xie, “Range-Focused Fusion of Camera-IMU-UWB for Accurate and Drift-Reduced Localization”, [online], IEEE, Feb. 8, 2021, [Searched on Jul. 4, 2022], Internet <URL: https://ieeexplore.ieee.org/document/9350155>
Non-Patent Document 2: Abhishek Goudar, Angela P. Schoellig, “Online Spatio-temporal Calibration of Tightly-coupled Ultrawideband-aided Inertial Localization”, [online], Jul. 31, 2021, arxiv, [Searched on Jul. 4, 2022], Internet <URL: https://arxiv.org/abs/2108.00133>

### SUMMARY OF THE INVENTION

### Problems to be Solved by the Invention

However, in the above-described technology, estimation of a self-position and posture by using only UWB as auxiliary information is substantially equivalent to estimation of a self-position and posture by using only UWB in a dark environment, for example.

The present technology has been made in view of such a situation, and an object thereof is to enable estimation of a self-position and posture with high accuracy.

### Solutions to Problems

A signal processing device according to one aspect of the present technology includes: a communication unit configured to receive distance measurement information between a first ultra wide band (UWB) device arranged in a predetermined space and a second UWB device provided in a mobile object, through UWB communication via the second UWB device; an LED feature point detection unit configured to detect a feature point based on a light source from an image obtained from an imaging unit and perform tracking between frames, the light source being arranged in the predetermined space and having a lighting timing controlled by a server on the basis of a time lag between the imaging unit provided in the mobile object and the server that controls the first UWB device; and a self-position and posture estimation unit configured to estimate a self-position and posture on the basis of a feature point of the light source, and correct the self-position and posture on the basis of the distance measurement information.

In the one aspect of the present technology, distance measurement information between the first ultra wide band (UWB) device arranged in a predetermined space and the second UWB device provided in a mobile object is received via the second UWB device through UWB communication, a feature point based on a light source is detected from an image obtained from an imaging unit, tracking is performed between frames, in which the light source is arranged in the predetermined space and has a lighting timing controlled by a server on the basis of a time lag between the imaging unit provided in the mobile object and the server that controls the first UWB device, a self-position and posture are estimated on the basis of a feature point of the light source, and the self-position and posture are corrected on the basis of the distance measurement information.

### BRIEF DESCRIPTION OF DRAWINGS

FIG. 1 is a diagram illustrating a configuration example of an appearance of a self-position and posture estimation system according to an embodiment of the present technology.

FIG. 2 is a block diagram illustrating a functional configuration example of a control server in FIG. 1.

FIG. 3 is a block diagram illustrating a functional configuration example of an HMD of FIG. 1.

FIG. 4 is a flowchart for explaining initialization processing.

FIG. 5 is a flowchart for explaining self-position and posture estimation processing.

FIG. 6 illustrates an example of a blinking pattern of an LED.

FIG. 7 is a diagram illustrating an example of pulses included in an exposure time in a case of a blinking pattern with ⅔ thinning.

FIG. 8 is a diagram illustrating an example of a lighting timing of the LED and an exposure timing of a camera.

FIG. 9 is a diagram illustrating an example of an exposure timing of the camera and a UWB distance measurement timing.

FIG. 10 is a diagram illustrating an example of light-emitting pixels of the LED in a case where a distance between the camera and the LED is short.

FIG. 11 is a diagram illustrating an example of light-emitting pixels of the LED in a case where a distance between the camera and the LED is long.

FIG. 12 is a block diagram illustrating a configuration example of a computer.

### MODE FOR CARRYING OUT THE INVENTION

Hereinafter, modes for carrying out the present technology will be described. The description will be given in the following order.
1. System configuration and device configuration
2. Processing flow
3. Processing details
4. Others

### 1. System Configuration and Device Configuration

### Configuration of Self-Position and Posture Estimation System

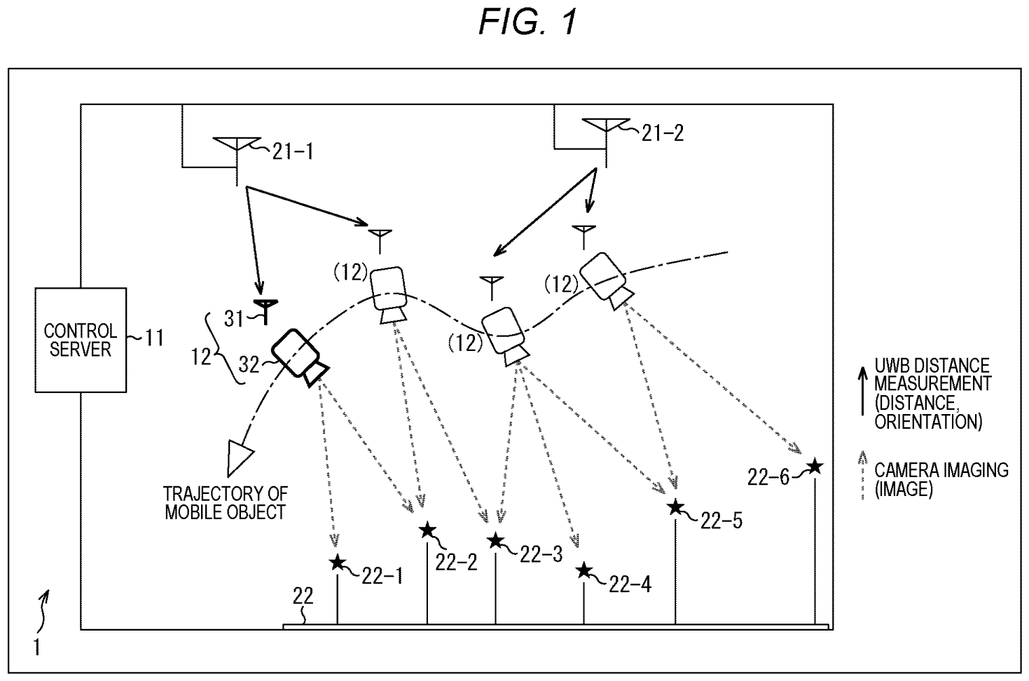

FIG. 1 is a diagram illustrating a configuration example of an appearance of a self-position and posture estimation system according to an embodiment of the present technology.

A self-position and posture estimation system 1 in FIG. 1 is roughly sectioned into a device arranged on an environment side and a device arranged on a mobile object side. In FIG. 1, a solid arrow indicates a distance measurement (observation) target by UWB, and a broken arrow indicates an imaging target by a camera 32 described later. A dash-dot-line arrow indicates a trajectory of an HMD 12 worn by a user who is a mobile object.

The self-position and posture estimation system 1 includes a control server 11 that controls a device arranged within a predetermined range on the environment side, and the HMD 12 configured to control a device arranged on the mobile object side.

On the environmental side, UWB anchors 21-1 and 21-2, which are first UWB devices, and an LED panel 23 including LEDs 22-1 to 22-6 are arranged. Note that the UWB anchors 21-1 and 21-2 will be referred to as UWB anchors 21 in a case where it is not necessary to distinguish them. The number of UWB anchors 21 is not limited to two. The LEDs 22-1 to 22-6 will be referred to as LEDs 22 in a case where it is not necessary to distinguish them.

The control server 11 controls a distance measurement timing of the UWB anchor 21 (hereinafter, also referred to as a UWB distance measurement timing) by a built-in timer (not illustrated), and acquires UWB distance measurement information measured by the UWB anchor 21. The UWB distance measurement information includes information indicating a distance and an orientation from the HMD 12 to the UWB anchor 21 measured by the UWB anchor 21. The control server 11 controls a lighting (light emission) timing of the LED 22 by a timer common to the UWB distance measurement timing.

Furthermore, the control server 11 receives an id (identity) of the HMD 12, information indicating a self-position and posture estimated by the HMD 12, information regarding exposure of the camera 32 (an imaging cycle and an exposure time), and the like through communication using UWB via the UWB anchor 21. Information exchanged through communication using UWB is also called metadata.

The HMD 12 is worn on the head of the user, and moves together with the user who is a mobile object. That is, the HMD 12 is configured as a part of the mobile object.

In the HMD 12 which is a part of the mobile object, a UWB tag 31 which is a second UWB device, and a sensor for estimating a self-position and posture such as the camera (imaging unit) 32 or an inertial measurement unit (IMU) (not illustrated) are arranged.

The HMD 12 receives, via the UWB tag 31, UWB distance measurement information measured by the UWB anchor 21 arranged on the environment side through communication using UWB, and refers to the UWB distance measurement information when estimating the self-position and posture. As a result, estimation accuracy of the self-position and posture can be improved.

The HMD 12 performs vision SLAM (VSLAM). That is, the HMD 12 estimates the self-position and posture by using a camera image captured by the camera 32.

The HMD 12 transmits, via the UWB tag 31, the id of the HMD 12, the information indicating the estimated self-position and posture, the information regarding exposure of the camera 32, and the like through communication using UWB. The id of the HMD 12 is, for example, an ID that can identify the HMD 12, such as a MAC address.

The UWB anchor 21 performs distance measurement of the UWB tag 31 at a UWB distance measurement timing supplied from the control server 11, acquires UWB distance measurement information including distance information and orientation information from the UWB tag 31 included in the HMD 12, and transmits the UWB distance measurement information to the control server 11.

The UWB anchor 21 communicates with the UWB tag 31 by using UWB, and receives information transmitted by the HMD 12. The UWB anchor 21 communicates with the UWB tag 31 by using UWB, and transmits information requested for transmission by the control server 11.

The LED panel 23 includes a plurality of LEDs 22. Predetermined LEDs 22-1 to 22-6 among the plurality of LEDs 22 are lit and lit off under the control of the control server 11.

The UWB tag 31 communicates with the UWB anchor 21 by using UWB, and receives UWB distance measurement information and the like. The UWB tag 31 communicates with the UWB anchor 21 by using UWB, and transmits information requested for transmission by the HMD 12.

The camera 32 outputs a camera image generated by imaging to the HMD 12.

In the self-position and posture estimation system 1, a lighting timing of the LED 22 and a UWB distance measurement timing are controlled to match with an exposure timing of the camera 32, on the basis of a time lag between the control server 11 and the camera 32.

Although details will be described later, the time lag between the control server 11 and the camera 32 is detected on the basis of the exposure timing of the camera 32 and the lighting timing of the LED 22 or the UWB distance measurement timing, in the control server 11 or the HMD 12. Then, the lighting timing of the LED 22 or the UWB distance measurement timing is controlled to match with the exposure timing.

As a result, the self-position and posture can be estimated with high accuracy.

Note that, in FIG. 1, the HMD 12 worn on the head of the user, which is an example of the mobile object, has been described as an example. However, the mobile object is not limited to the user, and may be any mobile object such as a robot, a carriage, a drone, or an animal. Furthermore, although the HMD 12 is worn on the head of the user, a portion of the HMD 12 that performs signal processing may be a signal processing device mounted on the mobile object, a server that is not worn on the mobile object, or the like.

### Configuration of Control Server

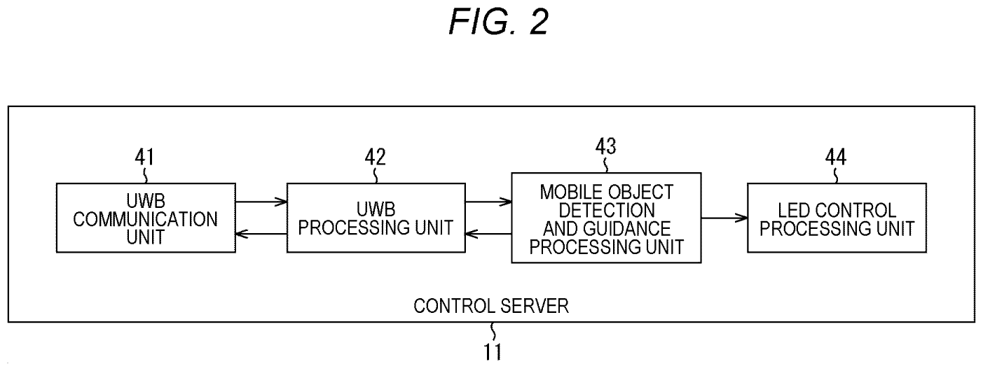

FIG. 2 is a block diagram illustrating a functional configuration example of the control server 11 of FIG. 1.

In FIG. 2, the control server 11 includes a UWB communication unit 41, a UWB processing unit 42, a mobile object detection and guidance processing unit 43, and an LED control processing unit 44.

The UWB communication unit 41 communicates with the UWB anchor 21.

The UWB processing unit 42 performs the following process related to UWB via the UWB communication unit 41 under the control of the mobile object detection and guidance processing unit 43.

That is, the UWB processing unit 42 causes the UWB anchor 21 to detect a new mobile object that has entered a predetermined range, and prompts the HMD 12 to perform initialization processing through communication using the UWB anchor 21.

The UWB processing unit 42 controls a UWB distance measurement timing for the UWB anchor 21, and acquires UWB distance measurement information measured by the UWB anchor 21.

The UWB processing unit 42 receives the id of the HMD 12, the information indicating the self-position and posture estimated by the HMD 12, the information regarding exposure, and the like via the UWB communication unit 41. The UWB processing unit 42 transmits the acquired UWB distance measurement information and information indicating the controlled UWB distance measurement timing to the HMD 12 via the UWB communication unit 41.

Furthermore, the UWB processing unit 42 transmits information regarding lighting of the LED 22 and the like to the HMD 12 via the UWB communication unit 41. The information regarding lighting is a position, a lighting timing, a lighting time, intensity, and the like of the LED 22 to be lit.

The UWB processing unit 42 outputs information supplied from the UWB communication unit 41 to the mobile object detection and guidance processing unit 43.

The mobile object detection and guidance processing unit 43 controls initialization processing of the HMD 12 in response to detection by the UWB anchor 21 and a UWB distance measurement timing. On the basis of the information supplied from the UWB processing unit 42, the mobile object detection and guidance processing unit 43 controls the UWB distance measurement timing so as to match with the exposure timing of the camera 32 of the HMD 12. Furthermore, the mobile object detection and guidance processing unit 43 calculates a lighting timing, a lighting time, and intensity of each of the LEDs 22-1 to 22-6 so as to match with the exposure timing of the camera 32 of the HMD 12, on the basis of the information supplied from the UWB processing unit 42.

The LED control processing unit 44 controls the lighting timing and the intensity of the LEDs 22-1 to 22-6 on the basis of the lighting timing, the lighting time, and the intensity calculated by the mobile object detection and guidance processing unit 43.

### Configuration of HMD

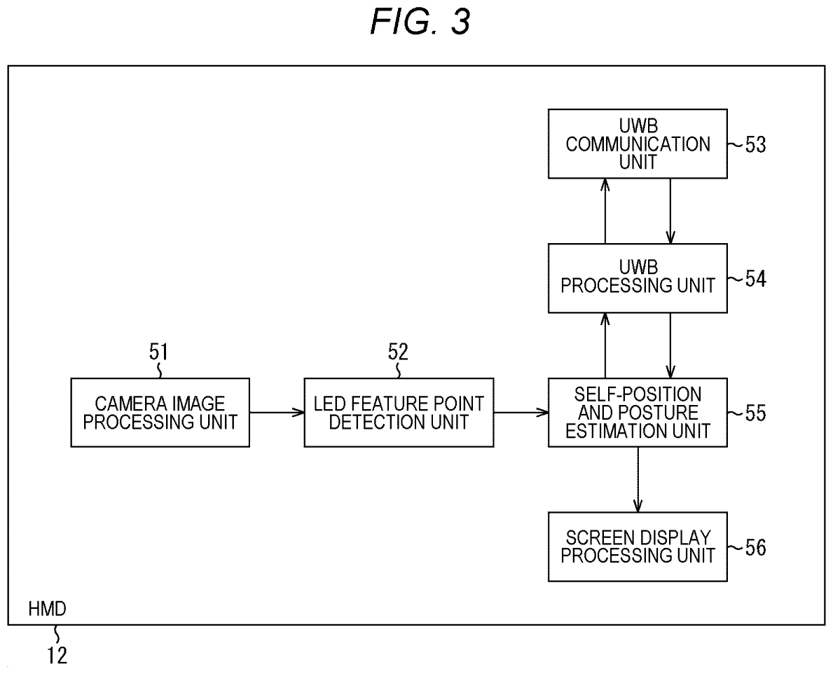

FIG. 3 is a block diagram illustrating a functional configuration example of the HMD of FIG. 1.

In FIG. 3, the HMD 12 includes a camera image processing unit 51, an LED feature point detection unit 52, a UWB communication unit 53, a UWB processing unit 54, a self-position and posture estimation unit 55, and a screen display processing unit 56.

The camera image processing unit 51 performs signal processing such as defect correction, noise reduction (NR) processing, and auto exposure (AE)/auto gain (AG) control on a camera image obtained by imaging with the camera 32. Furthermore, for the purpose of use in self-position estimation, the camera image processing unit 51 performs processing of extracting a feature point that is easily tracked between frames of the camera image and processing of matching the feature point between frames. The camera image processing unit 51 outputs the camera image after the signal processing and the feature point in the image to the LED feature point detection unit 52.

The LED feature point detection unit 52 detects a bright spot such as an LED as an LED feature point by using the camera image after the signal processing supplied from the camera image processing unit 51, and tracks the detected LED feature point between frames. The LED feature point detection unit 52 outputs information indicating the feature point in the image and information indicating the LED feature point being tracked, to the self-position and posture estimation unit 55.

The UWB communication unit 53 communicates with the UWB tag 31.

The UWB processing unit 54 performs the following process related to UWB via the UWB communication unit 53.

That is, the UWB processing unit 54 receives, via the UWB communication unit 53, UWB distance measurement information measured by the UWB tag 31, information indicating a UWB distance measurement timing, information regarding lighting of the LED 22, and the like.

The UWB processing unit 54 transmits the id of the HMD 12, information indicating a self-position and posture estimated by the self-position and posture estimation unit 55, information regarding exposure, and the like via the UWB communication unit 53.

The self-position and posture estimation unit 55 estimates the self-position and posture by combining the feature point in the image and the LED feature point being tracked, on the basis of the information supplied from the LED feature point detection unit 52. At that time, the estimated self-position and posture are corrected with reference to the UWB distance measurement information supplied from the UWB processing unit 54. Furthermore, information regarding lighting of the LED 22 is also referred to.

Information indicating the self-position and posture that are the estimation result of the self-position and posture is output to the UWB processing unit 54 and the screen display processing unit 56.

The screen display processing unit 56 performs control to display the information indicating the self-position and posture on a screen or the like of the HMD 12.

### 2. Processing Flow

In the self-position and posture estimation system 1, roughly, two types of processing are performed: initialization processing for performing self-position and posture estimation with high accuracy; and steady self-position and posture estimation processing.

### Initialization Processing of Self-Position and Posture Estimation System

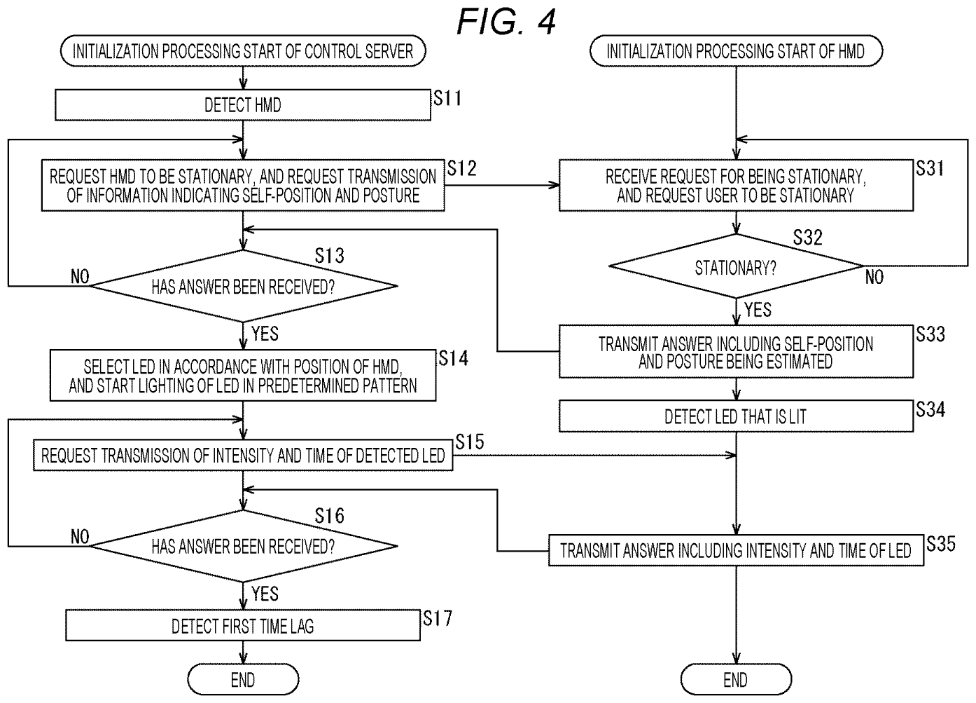

FIG. 4 is a flowchart for explaining initialization processing of the self-position and posture estimation system 1.

In FIG. 4, initialization processing of the control server 11 is illustrated on the left side, and initialization processing of the HMD 12 is illustrated on the right side. First, the initialization processing of the control server 11 will be described, and then the initialization processing of the HMD 12 will be described.

Note that, although a description of the UWB communication unit 41 is omitted in the description of FIG. 4, communication between the UWB processing unit 42 and the UWB anchor 21 is performed via the UWB communication unit 41 as described above. Similarly, although a description of the UWB communication unit 53 is omitted in the description of FIG. 4, communication between the UWB processing unit 54 and the UWB tag 31 is performed via the UWB communication unit 53 as described above. This similarly applies to the subsequent flowcharts.

In step S11, the UWB processing unit 42 of the control server 11 detects the HMD 12 that has newly entered within a predetermined range, by the UWB anchor 21 detecting the UWB tag 31 that has newly entered within the predetermined range. Whether or not the HMD 12 is new is determined by the id of the HMD 12 or the like.

In step S12, the UWB processing unit 42 requests the HMD 12 to be stationary through communication using UWB via the UWB anchor 21, and further requests transmission of information indicating a self-position and posture being estimated by the HMD 12 at that time.

In response to this, the HMD 12 transmits, via the UWB tag 31, an answer including the information indicating the self-position and posture being estimated, through communication using UWB (step S33 to be described later).

In step S13, the UWB processing unit 42 determines whether or not the answer (response) to the request in step S12 has been received from the HMD 12. In a case where it is determined in step S13 that the answer has not been received from the HMD 12, the process returns to step S12, and the subsequent processes are repeated.

Whereas, in a case where it is determined in step S13 that the answer has been received from the HMD 12, the process proceeds to step S14.

In step S14, under the control of the mobile object detection and guidance processing unit 43, the LED control processing unit 44 selects the LED 22 visible from the HMD 12 in accordance with the position of the HMD 12 on the basis of the information indicating the self-position and posture of the HMD 12 included in the received answer, and starts lighting of the selected LED 22 in a predetermined blinking pattern. Note that, although details of the process in step S14 will be described later, at this time, an exposure timing is acquired with reference to the information regarding exposure of the camera 32 transmitted from the HMD 12.

In step S15, the UWB processing unit 42 requests transmission of intensity and a time of the LED 22 detected by the HMD 12.

Whereas, the HMD 12 transmits an answer including information (for example, a blinking pattern) indicating the intensity and time of the detected LED 22, through communication using UWB via the UWB tag 31 (step S35 to be described later).

In step S16, the UWB processing unit 42 determines whether or not the answer to the request in step S15 has been received from the HMD 12. In a case where it is determined in step S16 that the answer has not been received from the HMD 12, the process returns to step S15, and the subsequent processes are repeated.

Whereas, in a case where it is determined in step S16 that the answer has been received from the HMD 12, the process proceeds to step S17. The UWB processing unit 42 outputs the blinking pattern of the LED 22 included in the received answer to the mobile object detection and guidance processing unit 43.

In step S17, the mobile object detection and guidance processing unit 43 refers to the predetermined blinking pattern controlled by itself and the blinking pattern received from the HMD 12, and detects a first time lag (including a cycle lag) on the basis of the exposure timing of the camera 32 and the lighting timing of the LED 22. That is, the first time lag is information indicating a time relationship between the exposure timing of the camera 32 and the lighting timing of the LED 22. Thereafter, the distance measurement timing and the lighting timing are controlled on the basis of the first time lag.

After the processing of step S17, the initialization processing of the control server 11 is ended.

Next, the initialization processing of the HMD 12 will be described.

As described above, the control server 11 requests the HMD 12 to be stationary and requests for the information indicating the self-position and posture being estimated by the HMD 12 at that time through communication using UWB via the UWB anchor 21 (step S12).

Whereas, the UWB processing unit 54 receives the request for being stationary, and requests the user to be stationary by, for example, displaying a UI on the screen of the HMD 12 in step S31.

In step S32, the UWB processing unit 54 determines whether or not the UWB processing unit 54 itself is stationary. In a case where it is determined in step S32 that the UWB processing unit 54 is not stationary, the process returns to step S31, and the subsequent processes are repeated.

In a case where it is determined in step S32 that the UWB processing unit 54 is stationary, the process proceeds to step S33.

Also during this period, the camera image processing unit 51, the LED feature point detection unit 52, and the self-position and posture estimation unit 55 continuously process the camera image obtained from the camera 32, detect and track the LED feature point, and estimate the self-position and posture.

In step S33, the UWB processing unit 54 transmits an answer including information indicating the self-position and posture being estimated, through communication using UWB via the UWB tag 31.

In step S34, the LED feature point detection unit 52 detects an LED feature point that is lit, from the camera image. The LED feature point detection unit 52 observes how the intensity of the LED feature point that is lit in a predetermined blinking pattern changes. Note that, at this time, control is performed on the camera 32 so that AE/AG does not change in time series. As a result, it is possible to more correctly detect the lighting and intensity pattern of the LED 22.

In step S35, the UWB processing unit 54 transmits an answer including information (for example, a blinking pattern) indicating the intensity and the time of the detected LED feature point to the control server 11 through communication using UWB via the UWB anchor 21. Thereafter, the initialization processing of the HMD 12 is ended.

### Self-Position Estimation Processing of Self-Position and Posture Estimation System

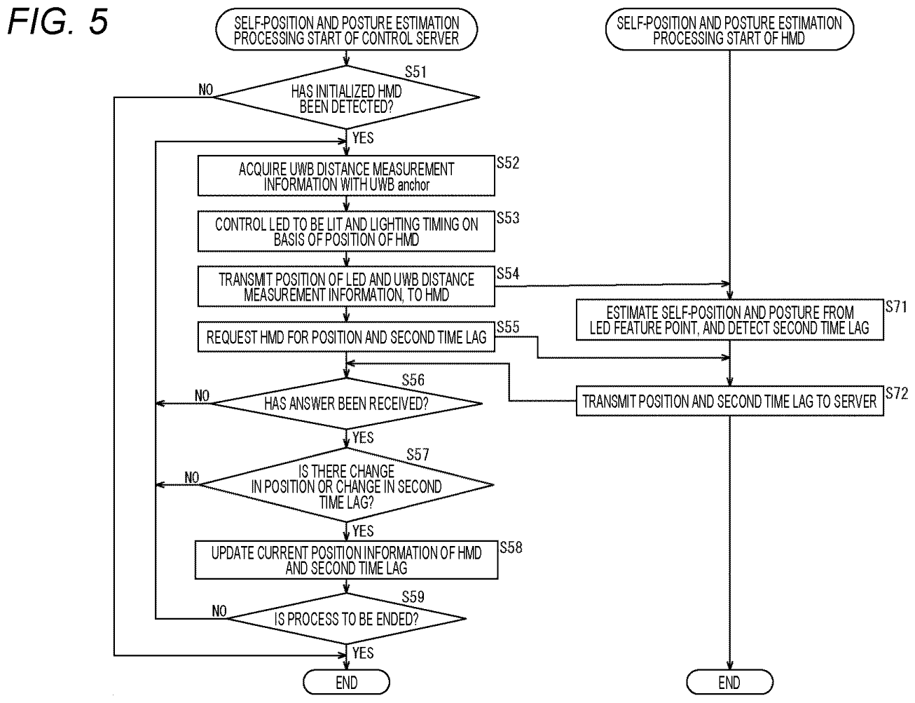

FIG. 5 is a flowchart for explaining self-position and posture estimation processing of the self-position and posture estimation system 1.

In FIG. 5, self-position and posture estimation processing of the control server 11 is illustrated on the left side, and self-position and posture estimation processing of the HMD 12 is illustrated on the right side. First, the self-position and posture estimation processing of the control server 11 will be described, and next, the self-position and posture estimation processing of the HMD 12 will be described.

In step S51, the UWB processing unit 42 of the control server 11 determines whether or not the initialized HMD 12 has been detected within a predetermined range, by the UWB anchor 21 detecting the UWB tag 31 that has entered the predetermined range. For example, an id of an initialized mobile object has been registered in a memory (not illustrated) or the like of the control server 11, and whether or not the mobile object is initialized is determined by the id of the HMD 12. In a case where it is determined in step S51 that the initialized HMD 12 has not been detected, the self-position and posture estimation processing of the control server 11 is ended.

In a case where it is determined in step S51 that the initialized HMD 12 has been detected, the process proceeds to step S52.

In step S52, the UWB processing unit 42 controls the UWB distance measurement timing, and acquires UWB distance measurement information measured by the UWB anchor 21.

At that time, the UWB distance measurement timing is controlled to be a timing synchronized with the exposure timing of the camera 32 of the HMD 12 obtained by the initialization processing. This is because, in the HMD 12, as the exposure timing of the camera 32 and the UWB distance measurement timing are closer, the self-position estimation becomes more accurate.

Furthermore, since the position and posture of the HMD 12 and the exposure timing of the camera 32 are known by the initialization processing of FIG. 4, the mobile object detection and guidance processing unit 43 extracts and selects the LED 22 that enters a field of view of the camera 32, on the basis of the position and posture of the HMD 12.

In step S53, the mobile object detection and guidance processing unit 43 controls the LED 22 to be lit and the lighting timing, on the basis of the position of the HMD 12. At this time, the lighting timing is also controlled to be a timing synchronized with the exposure timing of the camera 32 of the HMD 12.

Note that a three-dimensional position of the LED 22 to be lit in a predetermined space can be obtained in advance by measuring a distance with a highly accurate distance measuring jig or the like.

In step S54, the UWB processing unit 42 transmits the three-dimensional position of the LED 22 to be lit, the UWB distance measurement information, and the UWB distance measurement timing, to the HMD 12 through communication using UWB via the UWB anchor 21.

In step S55, the UWB processing unit 42 requests the HMD 12 to transmit the position and a second time lag detected in the HMD 12. The second time lag is detected by the HMD 12 on the basis of a time relationship between the exposure timing of the camera 32 and the UWB distance measurement timing. That is, the second time lag is information indicating a time relationship between the exposure timing of the camera 32 and the UWB distance measurement timing of the LED 22.

Note that, although details will be described later, since both the control of the lighting timing of the LED 22 and the control of the UWB distance measurement timing are performed at an exposure center (center of an exposure time) of the imaging unit, both the first time lag and the second time lag are time lags of the control server 11 and the camera 32, and indicate lags of the same amount.

In response to the request in step S55, the HMD 12 transmits an answer including information indicating the position and the second time lag, through communication using UWB via the UWB tag 31 (step S72 to be described later).

In step S56, the UWB processing unit 42 determines whether or not the answer to the request in step S55 has been received from the HMD 12. In a case where it is determined in step S56 that the answer has not been received from the HMD 12, the process returns to step S55, and the subsequent processes are repeated.

Whereas, in a case where it is determined in step S56 that the answer has been received from the HMD 12, the process proceeds to step S57.

In step S57, the UWB processing unit 42 determines whether or not there is a change in the position or a change in the second time lag on the basis of the information included in the received answer. In a case where it is determined in step S57 that there is no change in the position and no change in the second time lag, the process returns to step S52, and the subsequent processes are repeated.

In a case where it is determined in step S57 that there is a change in the position or a change in the second time lag, the process proceeds to step S58.

In step S58, the UWB processing unit 42 updates current position information of the HMD 12 and the second time lag information. Thereafter, the distance measurement timing and the lighting timing are controlled on the basis of the second time lag.

In step S59, the UWB processing unit 42 determines whether or not to end the process. For example, in a case where the HMD 12 can no longer be found, the LED feature point can no longer be detected, or the time lag becomes a certain amount (threshold value) or more, it is determined as an error, and it is determined to end the process. In a case where it is determined in step S59 not to end the process, the process returns to step S52, and the subsequent processes are repeated.

In a case where it is determined in step S59 to end the process, the self-position and posture estimation processing of the control server 11 is ended.

Next, the self-position and posture estimation processing of the HMD 12 will be described.

As described above, the control server 11 transmits the three-dimensional position of the LED 22 to be lit to the HMD 12 in addition to the UWB distance measurement information, through communication using UWB via the UWB anchor 21 (step S54).

Whereas, the UWB processing unit 54 receives the information from the control server 11, and estimates a self-position and posture on the basis of the three-dimensional position of the LED 22 and an LED feature point, in step S71. At that time, the UWB processing unit 54 evaluates a relationship between the UWB distance measurement information and the estimated self position, and detects the second time lag on the basis of the UWB distance measurement timing and the exposure timing of the camera 32. As a result, it is possible to detect a time lag occurring after initialization.

Moreover, as described above, the control server 11 requests the HMD 12 to transmit the position and the second time lag, through communication using UWB via the UWB anchor 21 (step S55).

Whereas, in step S72, the UWB processing unit 54 transmits an answer including information indicating the position and the second time lag, to the control server 11, through communication using UWB via the UWB tag 31. Thereafter, the self-position estimation processing of the HMD 12 is ended.

Note that, here, the answer including the information about the position and the second time lag is transmitted in response to the request from the control server 11, but the information about the position and the second time lag may be transmitted from the HMD 12 in a case where at least one of the position or the second time lag is present.

In addition, as the second time lag detection method in step S71, for example, the method of Non-Patent Document 1 or Non-Patent Document 2 can be used. However, in order to detect the second time lag with high accuracy by either of the methods, it is necessary that the feature point of the image or the like is rich to some extent, movement is simple, and the posture itself is easily estimated.

According to the present technology, it is possible to detect not only the second time lag but also a fine time lag, by controlling lighting of the LED 22 together or performing processing of detecting the first time lag in advance by the initialization processing.

In addition, in the HMD 12, in a case where the corresponding LED feature point is not found or in a case where there is a contradiction between the estimated self position and the distance information and orientation information of the UWB, the initialization processing may be requested (prompted) again, and the second time lag can be verified using the LED feature point, the lighting timing of the LED, and the like.

That is, in the HMD 12, since the lighting of the LED 22 is no longer visible, it is possible to detect the first time lag that is a time relationship between the lighting timing and the exposure timing of the LED 22, and detect abnormality such as timing deviation. As a result, the initialization processing can be performed again.

Moreover, the exposure timing of the HMD 12 in the camera 32 may slightly change due to a change in AE or the like. Therefore, the control server 11 receives the information about the detected second time lag together with the self position from the camera 32 of the HMD 12, correspondingly performs appropriate determination and lighting of the LED 22, performs lighting of the LED feature point necessary for estimating the self-position and posture, and outputs the UWB distance measurement information to the camera 32 at a predetermined position. As a result, estimation accuracy of the self-position and posture can be improved.

### 3. Processing Details

### Lighting Timing Control of LED in Initialization Processing

Currently, there is IEEE 1588 picture transfer protocol (PTP) as a protocol for computer synchronization via a network, and time synchronization at a sub-microsecond level can be achieved. That is, the control server 11 and the HMD 12 can achieve time synchronization. However, in the HMD 12, management of a time synchronized via a network and an imaging time (exposure time) of the camera 32 is left to individual devices, and it is difficult to cooperate an external timing with the exposure time of the camera 32 of the mobile object and verify the accuracy thereof.

Therefore, in the present technology, lighting timing control of the LED 22 in step S14 of the initialization processing of FIG. 4 is performed. The lighting timing control of the LED 22 in step S14 will be described in detail below.

After receiving the answer in step S13 of FIG. 4 described above, the following process is performed in step S14. Note that, although not illustrated in FIG. 4, the process in step S13 is performed by exchange between the control server 11 and the HMD 12.

First, the HMD 12 sets a time of the control server 11 as master and adjusts a time of the HMD 12 by an existing procedure such as PTP by a network synchronization technique. The HMD 12 transmits scale lag (cycle lag) information of the time of the HMD 12 to the control server 11, on the basis of time stamps before and after the time adjustment.

Furthermore, the HMD 12 confirms information regarding exposure of the camera 32 (an imaging cycle and an exposure time) by using an imaging device application programming interface (API), and transmits the information to the control server 11 through UWB communication. Note that a center of the exposure time (hereinafter, an exposure center) is the exposure timing.

The control server 11 first causes the LED 22 to be lit. The HMD 12 detects an LED feature point corresponding to the lit LED 22 in the camera image.

When the control server 11 is notified by the HMD 12 that the LED feature point has been detected, the control server 11 causes the LED 22 to be lit at a high speed at a constant cycle and periodically lights off.

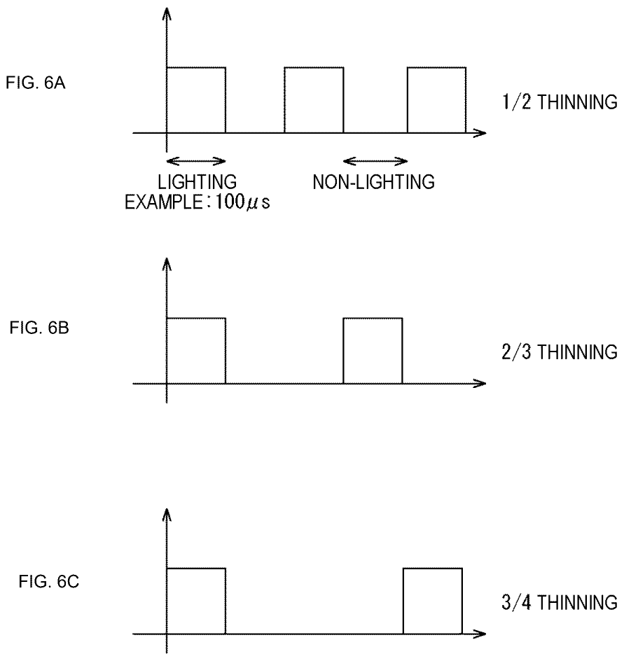

FIG. 6 is a diagram illustrating an example of a blinking pattern of the LED 22 in a case where the lighting time is 100 μs.

A of FIG. 6 illustrates an example of a blinking pattern of the LED 22 in a case where the lighting time is 100 μs by thinning out ½. In this case, ½ of one cycle is the lighting time (100 μs), and ½ of one cycle is the non-lighting time (100 μs). That is, the minimum unit in which the lighting can be controlled is 200 μs.

B of FIG. 6 illustrates an example of a blinking pattern of the LED 22 in a case where the lighting time is 100 μs by thinning out ⅔. In this case, ⅓ of one cycle is the lighting time (100 μs), and ⅔ of one cycle is the non-lighting time (200 μs). That is, the minimum unit in which the lighting can be controlled is 300 μs.

C of FIG. 6 illustrates an example of a blinking pattern of the LED 22 in a case where the lighting time is 100 μs by thinning out ¾. In this case, ¼ of one cycle is the lighting time (100 μs), and ¾ of one cycle is the non-lighting time (300 μs). That is, the minimum unit in which the lighting can be controlled is 400 μs.

The control server 11 thins out and reduces the lighting time in the order of A of FIG. 6 to C of FIG. 6, for example, until a pixel value detected as the LED 22 in the camera 32 is no longer saturated. That is, the control server 11 searches for a blinking pattern that does not cause saturation, by gradually expanding the minimum unit in which the lighting can be controlled.

Note that, at this time, a gain is desirably set as small as possible in the camera 32.

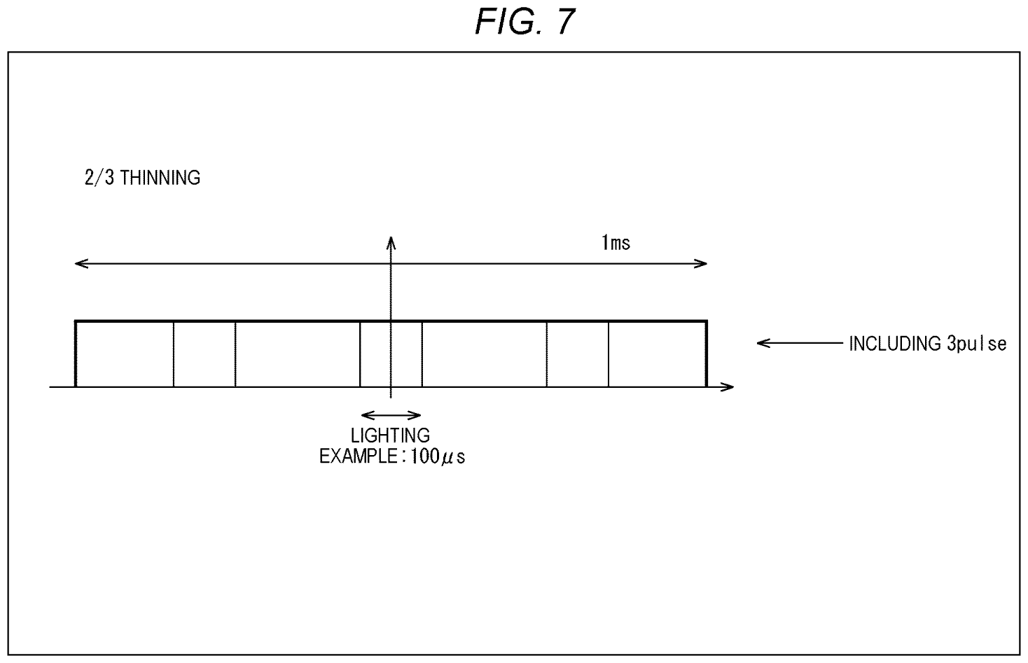

Then, the control server 11 calculates the maximum number of pulses included in the exposure time while maintaining the blinking pattern. As illustrated in FIG. 7, the control server 11 causes the LED 22 to be lit with pulses of that number (three pulses).

FIG. 7 is a diagram illustrating an example of pulses included in the exposure time in a case of a blinking pattern with ⅔ thinning.

FIG. 7 illustrates an example in which, in a case where the lighting time is 100 μs, the exposure time (1 ms) includes up to three pulses.

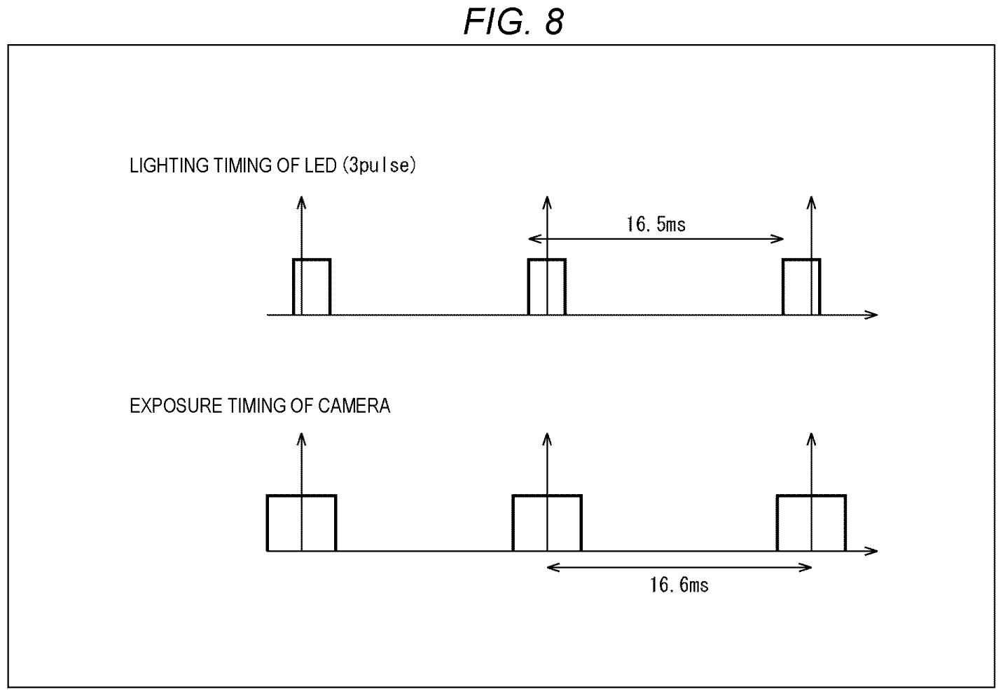

Then, as illustrated in the next FIG. 8, the control server 11 changes the lighting cycle of the LED 22 by slightly shifting the imaging cycle of the camera 32.

FIG. 8 is a diagram illustrating an example of the lighting timing of the LED 22 and the exposure timing of the camera 32.

In FIG. 8, a vertical arrow represents the exposure center (exposure timing) of the camera 32.

The upper side of FIG. 8 illustrates the lighting timing of the LED 22 in a case where the lighting cycle is 16.5 ms with respect to the exposure center of the camera 32. Note that the lighting cycle represents a cycle from the lighting timing to the next lighting timing. The lighting timing is slightly shifted from the exposure center. This shift is a first time lag.

The lower side of FIG. 8 illustrates the exposure timing of the camera 32 in a case where the imaging cycle is 16.6 ms (=30 fps) with respect to the exposure center of the camera 32. The imaging cycle represents a cycle from the exposure center to the next exposure center.

That is, the control server 11 slightly shifts the lighting cycle of 16.5 ms of the LED 22 to change the lighting cycle to approach the imaging cycle of 16.6 ms of the camera 32. Then, the control server 11 determines that the lighting timing of the LED 22 when a signal value of the LED 22 becomes the highest coincides with the exposure timing.

In step S17 of FIG. 4 described above, the process of detecting such timing that is the first time lag is performed, and thereafter, the control server 11 controls lighting of the LED 22 at the lighting timing of the LED 22 determined to be coincident. In this manner, the lighting timing is controlled to cause lighting only for the exposure time.

That is, by matching the lighting timing of the blinking pattern with the exposure timing of the camera 32 on the HMD 12 side, the signal value of the camera 32 becomes the highest. Furthermore, by matching the lighting cycle and the imaging cycle (for example, 16.6 ms), the signal value is stably maintained at a constant value regardless of a frame.

### Control of UWB Distance Measurement Timing in Self-Position Estimation Processing

The UWB distance measurement timing is controlled by a timer built in the control server 11 that controls the LED 22, and the exposure timing is controlled by a timer of the camera 32.

In order to estimate the self-position and posture with high accuracy by integrating the self-position and posture estimation result from the image of the camera 32 with the UWB distance measurement information, it is necessary to accurately detect a time relationship between the exposure timing, which is the second time lag, and the UWB distance measurement timing. That is, by detecting the second time lag, the UWB distance measurement timing is more accurately controlled.

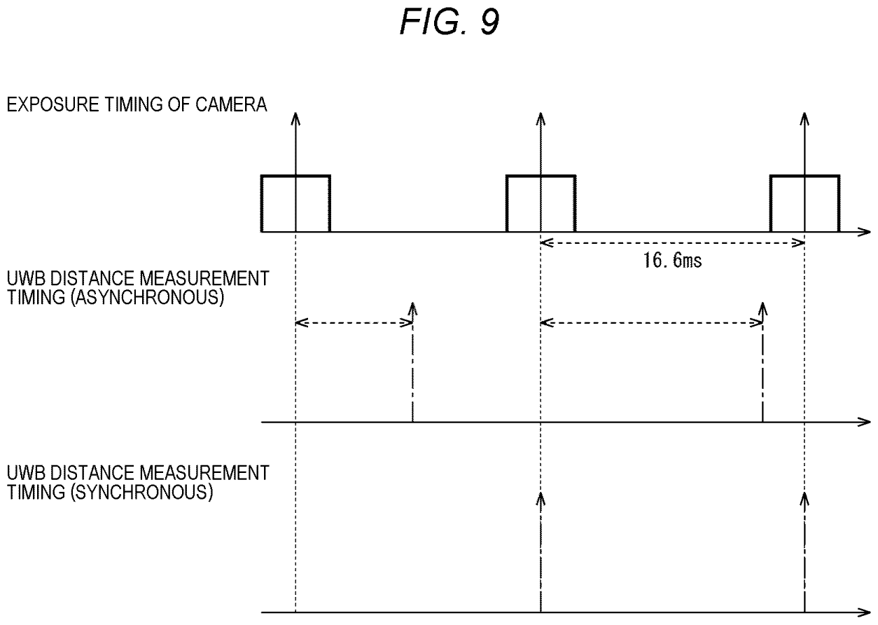

FIG. 9 is a diagram illustrating an example of an exposure timing of the camera 32 and a UWB distance measurement timing.

FIG. 9 indicates, in order from the top, an exposure timing of the camera 32, a UWB distance measurement timing in a case of being asynchronous, and a UWB distance measurement timing in a case of being synchronized according to the present technology.

Conventionally, the exposure timing of the camera 32 and the UWB distance measurement timing are asynchronous and shifted from each other. This shift is the second time lag. However, as described above, according to the present technology, since the control server 11 can know the exposure timing of the camera 32 via the HMD 12 in the initialization processing, the UWB distance measurement timing can be brought as close as possible to the exposure timing.

That is, since the exposure time can be accurately detected to some extent, by matching the UWB distance measurement timing with the exposure timing (exposure center) on the basis of this information and then measuring a distance between the UWB anchor on the environment side and the UWB tag of the HMD 12, the estimation of the self-position and posture can be achieved with higher accuracy.

Note that, as described above, since both the control of the lighting timing of the LED 22 and the control of the UWB distance measurement timing are performed at the exposure center of the camera 32, both the first time lag and the second time lag are time lags of the control server 11 and the camera 32, and indicate the same amount of shift.

That is, in both a case where the first time lag is detected and a case where the second time lag is detected, the lighting timing of the LED 22 and the UWB distance measurement timing are controlled to match with the exposure timing. As a result, estimation of the self-position and posture can be achieved with high accuracy.

### Control of Intensity of LED

In a case where the HMD 12 tracks the LED feature point, the number of bright spots shown in the image is preferably about 1 pix to several pixs on the image. This is because the tracking accuracy decreases when the bright spot becomes about 10 pixs. Furthermore, conversely, if the bright spot is less than 1 pix, it may be difficult to detect light.

Depending on a positional relationship between the camera 32 of the HMD 12 and the LED 22, the extent to which the lighting (light emission) of the LED 22 has spread of pixels (magnitude of lighting) of the camera 32 on the image changes.

For example, in a case where the camera 32 is too close to the LED 22, a pixel reflected in the camera 32 has a large spread, and thus, there is a possibility that the signal value is saturated. Conversely, in a case where the camera 32 is too far from the LED 22, there is a possibility that an amount of light is small and the light is not reflected in the camera 32. In both cases, it is difficult for the HMD 12 to stably track the bright spot (LED feature point) of the LED 22.

Therefore, the control server 11 controls the spread and intensity of the LED 22 shown in an image obtained from the camera 32 by increasing the number of light-emitting pixels of the LED 22 (increasing the spread of light emission) or changing the light emission intensity in accordance with the positional relationship between the camera 32 and the LED 22.

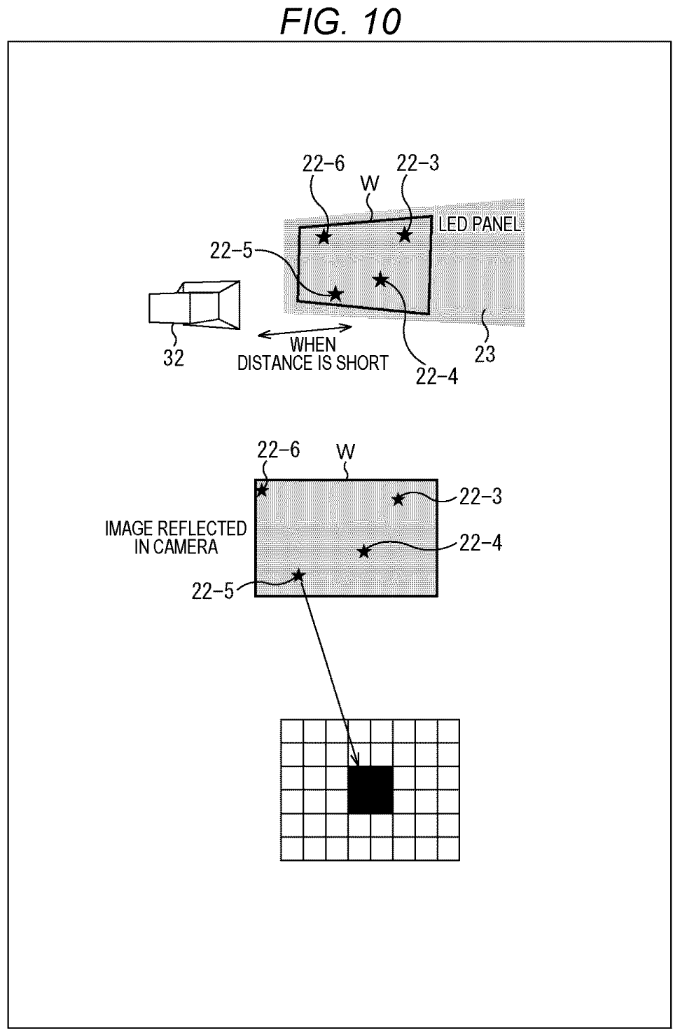

FIG. 10 is a diagram illustrating an example of light-emitting pixels of the LED 22 in a case where a distance between the camera 32 and the LED 22 is short.

In FIG. 10, an angle of view W of the camera 32 includes the LEDs 22-3 to 22-6 emitting light in the LED panel 23.

That is, in a camera image indicated by the angle of view W of the camera 32, the emitting LEDs 22-3 to 22-6 of the LED panel 23 are shown.

Since the distance between the camera 32 and the LED 22 is short, in practice, for example, four light-emitting pixels are lit as the LED 22-5.

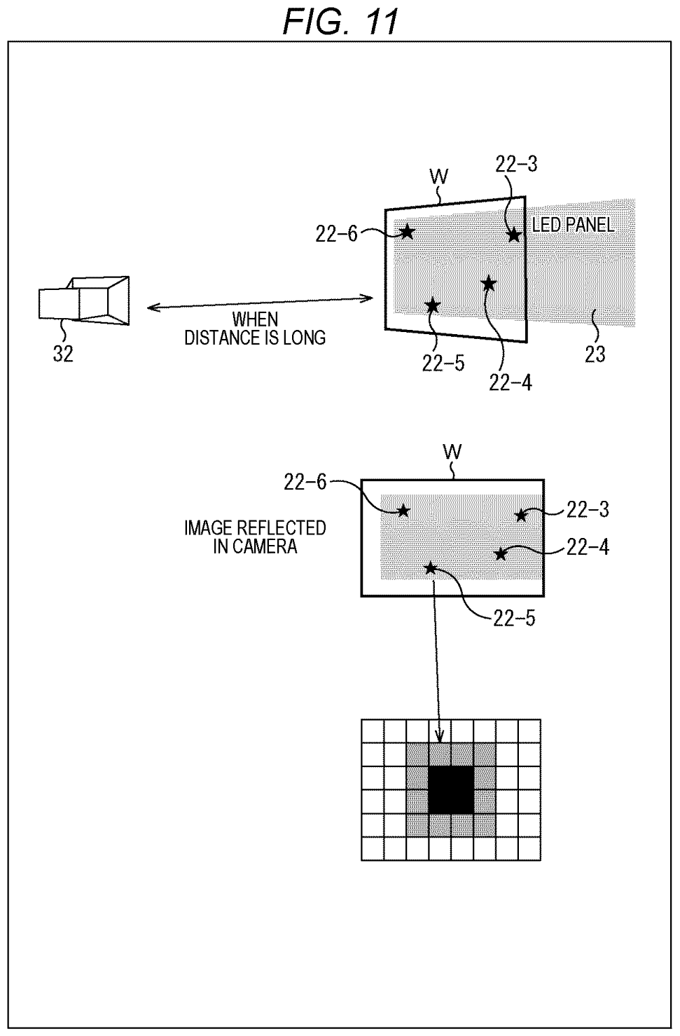

FIG. 11 is a diagram illustrating an example of light-emittingpixels of the LED 22 in a case where a distance between the camera 32 and the LED 22 is long.

In FIG. 11, the angle of view W of the camera 32 includes the LEDs 22-3 to 22-6 emitting light in the LED panel 23, together with an upper end, a lower end, and a left end of the LED panel 23.

That is, in a camera image indicated by the angle of view W of the camera 32, the emitting LEDs 22-3 to 22-6 of the LED panel 23 are shown together with the upper end, the lower end, and the left end of the LED panel 23.

In the camera image indicated by the angle of view W of the camera 32, the LEDs 22-3 to 22-6 are shown with the same size (light amount) as the LEDs 22-3 to 22-6 in FIG. 10.

However, since the distance between the camera 32 and the LED 22 is long, actually, for example, as the LED 22-5, nine light-emitting pixels around the four light-emitting pixels are lit in addition to the four light-emitting pixels in FIG. 10.

As described above, the number (spread) and intensity of light-emitting pixels of the LED 22 may be controlled by the control server 11 in accordance with the positional relationship between the camera 32 and the LED 22. Since an appropriate amount of light is given to the camera 32 by appropriately controlling a light emission position, a location, and intensity of the LED 22, it is possible to more efficiently assist the estimation of the self-position and posture performed on the camera 32 side.

### 4. Others

### Effects of Present Technology

In the present technology, an image generated by the imaging unit is processed, and distance measurement information between the first UWB device arranged in a predetermined space and the second UWB device provided to itself is received via the second UWB device through UWB communication. In addition, a feature point of an LED whose lighting timing is controlled by the server is detected from the image on the basis of a time lag between itself and the server that controls the first UWB device, tracking is performed between frames, and the self position is estimated on the basis of the distance measurement information and the feature point of the LED.

Therefore, since the LED can be lit only at a necessary position and timing of the LED so as to reduce an influence of the lighting of the LED, the self-position estimation can be performed at low cost and with high accuracy while utilizing the UWB and the LED.

As a result, it is possible to suppress the cost and power consumption on the environment side while achieving highly accurate self-position estimation by utilizing UWB and LED, to compensate for the drawback of InSide-Out.

At present, regarding the exposure timing of the camera (image sensor), information about the exposure timing is not often transmitted to the application layer. Therefore, in a case where an application or a service using an existing product such as a smartphone is provided, it becomes difficult to cooperate with the camera, and there is a possibility that the cost of the system itself increases, for example, it is necessary to separately prepare a dedicated terminal.

According to the present technology, even in such a situation, an exposure timing of an existing camera is acquired by utilizing the LED and the UWB, and a self position of the mobile object can be estimated by closely cooperating information about the environment and the camera of the mobile object. Therefore, it is possible to estimate the self position of the mobile object with high accuracy even in an environment where it is difficult to estimate the position by the camera alone of the mobile object, while utilizing a general-purpose regulation product.

Furthermore, according to the present technology, since only necessary LEDs can be lit only at a necessary timing, power consumption can be suppressed.

As a result, the LEDs can be caused to blink in different patterns with respect to individual exposure timings according to the mobile objects, so that it is possible to provide auxiliary information for instructing different actions for the individual mobile objects.

Then, for example, an LED such as an LED display for advertisement or event can be used for guiding the HMD 12 such that a predetermined LED is strongly illuminated only at a very limited specific timing for a short period of time, and thus, it is possible to influence only the HMD 12 without affecting human eyes. Thus, light emission of the LED installed for other purposes can be utilized.

Note that, in the above description, the LED has been described as an example, but the light source is not limited to the LED, and may be any light source as long as the lighting timing can be controlled.

### Configuration Example of Computer

The series of processes described above can be performed by hardware or by software. When the series of processing is executed by software, a program included in the software is installed from a program recording medium on a computer incorporated in dedicated hardware, a general-purpose personal computer, or the like.

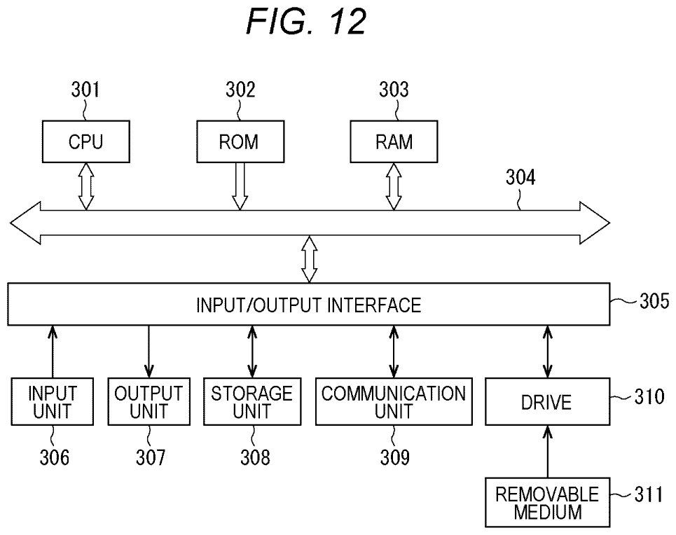

FIG. 12 is a block diagram illustrating a configuration example of hardware of a computer that performs the series of processing described above in accordance with a program. A central processing unit (CPU) 301, a read only memory (ROM) 302, and a random access memory (RAM) 303 are connected to each other by a bus 304.

Moreover, to the bus 304, an input/output interface 305 is connected. To the input/output interface 305, an input unit 306 including a keyboard, a mouse, and the like, and an output unit 307 including a display, a speaker, and the like are connected. Furthermore, to the input/output interface 305, a storage unit 308 including a hard disk, a nonvolatile memory, and the like, a communication unit 309 including a network interface and the like, and a drive 310 that drives a removable medium 311 are connected.

In the computer configured as described above, the above-described series of processing steps is executed, for example, by the CPU 301 loading the program stored in the storage unit 308 into the RAM 303 via the input/output interface 305 and the bus 304 and executing the program.

The program executed by the CPU 301 is stored, for example, in the removable medium 311 and provided or provided through a wired or wireless transmission medium such as a local area network, the Internet, or digital broadcasting, and installed in the storage unit 308.

Note that the program executed by the computer may be a program for processing in time series in the order described in the present description, or a program for processing in parallel or at a necessary timing such as when a call is made.

Note that, in the present specification, a system means an assembly of a plurality of components (devices, modules (parts), and the like), and it does not matter whether or not all the components are located in the same housing. Therefore, a plurality of devices housed in separate housings and connected to each other via a network and one device in which a plurality of modules is housed in one housing are both systems.

In addition, the effects described herein are merely examples and not restrictive, and there may also be other effects.

An embodiment of the present technology is not limited to the embodiment described above, and various modifications can be made without departing from the scope of the present technology.

For example, the present technology may be embodied as cloud computing in which one function is shared by a plurality of devices via a network and is processed in cooperation.

Furthermore, each step described in the flowchart described above can be performed by one device or can be shared and performed by a plurality of devices.

Moreover, in a case where a plurality of pieces of processing is included in one step, the plurality of pieces of processing included in the one step can be executed by one device or executed by a plurality of devices in a shared manner.

### Combination Example of Configuration

The present technology can also have the following configurations.

(1)

A signal processing device including:

a communication unit configured to receive distance measurement information between a first ultra wide band (UWB) device arranged in a predetermined space and a second UWB device provided in a mobile object, through UWB communication via the second UWB device;

an LED feature point detection unit configured to detect a feature point based on a light source from an image obtained from an imaging unit and perform tracking between frames, the light source being arranged in the predetermined space and having a lighting timing controlled by a server on the basis of a time lag between the imaging unit provided in the mobile object and the server that controls the first UWB device; and

a self-position and posture estimation unit configured to estimate a self-position and posture on the basis of a feature point of the light source, and correct the self-position and posture on the basis of the distance measurement information.

(2)

The signal processing device according to (1) above, in which

the time lag is a first time lag detected by initialization processing on the basis of an exposure timing of the imaging unit and the lighting timing.

(3)

The signal processing device according to (2) above, in which

the communication unit transmits information regarding exposure and obtained from the imaging unit, to the server through the UWB communication, and

the first time lag is detected by the server.

(4)

The signal processing device according to (3) above, in which

the lighting timing is controlled by the server to match with the exposure timing, on the basis of the first time lag.

(5)

The signal processing device according to (3) or (4) above, in which

a distance measurement timing of the distance measurement information is controlled by the server to match with the exposure timing, on the basis of the first time lag.

(6)

The signal processing device according to any one of (2) to (5) above, in which

the time lag is a second time lag detected after the initialization processing on the basis of the exposure timing and a distance measurement timing of the distance measurement information.

(7)

The signal processing device according to (6) above, further including:

a control unit configured to detect the second time lag.

(8)

The signal processing device according to (7) above, in which

the control unit requests the initialization processing in a case where the control unit further detects the first time lag after detecting the second time lag.

(9)

The signal processing device according to (7) or (8) above, in which

the communication unit transmits information indicating the second time lag, to the server through the UWB communication.

(10)

The signal processing device according to (9) above, in which

the lighting timing is controlled by the server to match with the exposure timing, on the basis of the second time lag.

(11)

The signal processing device according to (9) or (10) above, in which

the distance measurement timing is controlled by the server to match with the exposure timing, on the basis of the second time lag.

(12)

The signal processing device according to any one of (1) to (11) above, in which

the lighting timing is controlled by the server to cause the light source to be lit only for an exposure time of the imaging unit.
(13)

The signal processing device according to any one of (1) to (12) above, in which

in the light source, spread or intensity of light emission is controlled by the server on the basis of a distance between the imaging unit and the light source.

(14)

The signal processing device according to any one of (1) to (13) above, in which

the signal processing device is mounted to the mobile object.

(15)

The signal processing device according to any one of (1) to (14) above, in which

the light source is an LED.

(16)

The signal processing device according to any one of (1) to

(15) above, in which

the distance measurement information is distance information and orientation information.

(17) A signal processing method including,

by a signal processing device:

receiving distance measurement information between a first ultra wide band (UWB) device arranged in a predetermined space and a second UWB device provided in a mobile object, through UWB communication via the second UWB device;

detecting a feature point based on a light source from an image obtained from an imaging unit and performing tracking between frames, the light source being arranged in the predetermined space and having a lighting timing controlled by a server on the basis of a time lag between the imaging unit provided in the mobile object and the server that controls the first UWB device; and

estimating a self-position and posture on the basis of a feature point of the light source, and correcting the self-position and posture on the basis of the distance measurement information.

(18)

A program for causing a computer to function as:

a communication unit configured to receive distance measurement information between a first ultra wide band (UWB) device arranged in a predetermined space and a second UWB device provided in a mobile object, through UWB communication via the second UWB device;

an LED feature point detection unit configured to detect a feature point based on a light source from an image obtained from an imaging unit and perform tracking between frames, the light source being arranged in the predetermined space and having a lighting timing controlled by a server on the basis of a time lag between the imaging unit provided in the mobile object and the server that controls the first UWB device; and

a self-position and posture estimation unit configured to estimate a self-position and posture on the basis of a feature point of the light source, and correct the self-position and posture on the basis of the distance measurement information.

### REFERENCE SIGNS LIST

1 Self-position and posture estimation system
11 Control server
12 HMD
21 UWB anchor
22, 22-1 to 22-6 LED
23 LED panel
31 UWB tag
32 Camera
41 UWB communication unit
42 UWB processing unit
43 Mobile object detection and guidance processing unit
44 LED control processing unit
51 Camera image processing unit
52 LED feature point detection unit
53 UWB communication unit
54 UWB processing unit
55 Self-position and posture estimation unit
56 Screen display processing unit

1. A signal processing device comprising:
a communication unit configured to receive distance measurement information between a first ultra wide band (UWB) device arranged in a predetermined space and a second UWB device provided in a mobile object, through UWB communication via the second UWB device;
an LED feature point detection unit configured to detect a feature point based on a light source from an image obtained from an imaging unit and perform tracking between frames, the light source being arranged in the predetermined space and having a lighting timing controlled by a server on a basis of a time lag between the imaging unit provided in the mobile object and the server that controls the first UWB device; and
a self-position and posture estimation unit configured to estimate a self-position and posture on a basis of a feature point of the light source, and correct the self-position and posture on a basis of the distance measurement information.

2. The signal processing device according to claim 1, wherein
the time lag includes a first time lag detected by initialization processing on a basis of an exposure timing of the imaging unit and the lighting timing.

3. The signal processing device according to claim 2, wherein
the communication unit transmits information regarding exposure and obtained from the imaging unit, to the server through the UWB communication, and
the first time lag is detected by the server.

4. The signal processing device according to claim 3, wherein
the lighting timing is controlled by the server to match with the exposure timing, on a basis of the first time lag.

5. The signal processing device according to claim 3, wherein
a distance measurement timing of the distance measurement information is controlled by the server to match with the exposure timing, on a basis of the first time lag.

6. The signal processing device according to claim 2, wherein
the time lag includes a second time lag detected after the initialization processing on a basis of the exposure timing and a distance measurement timing of the distance measurement information.

7. The signal processing device according to claim 6, further comprising:
a control unit configured to detect the second time lag.

8. The signal processing device according to claim 7, wherein
the control unit requests the initialization processing in a case where the control unit further detects the first time lag after detecting the second time lag.

9. The signal processing device according to claim 7, wherein
the communication unit transmits information indicating the second time lag, to the server through the UWB communication.

10. The signal processing device according to claim 9, wherein
the lighting timing is controlled by the server to match with the exposure timing, on a basis of the second time lag.

11. The signal processing device according to claim 9, wherein
the distance measurement timing is controlled by the server to match with the exposure timing, on a basis of the second time lag.

12. The signal processing device according to claim 1, wherein
the lighting timing is controlled by the server to cause the light source to be lit only for an exposure time of the imaging unit.

13. The signal processing device according to claim 1, wherein
in the light source, spread or intensity of light emission is controlled by the server on a basis of a distance between the imaging unit and the light source.

14. The signal processing device according to claim 1, wherein
the signal processing device is mounted to the mobile object.

15. The signal processing device according to claim 1, wherein
the light source includes an LED.

16. The signal processing device according to claim 1, wherein
the distance measurement information includes distance information and orientation information.

17. A signal processing method comprising
by a signal processing device:
receiving distance measurement information between a first ultra wide band (UWB) device arranged in a predetermined space and a second UWB device provided in a mobile object, through UWB communication via the second UWB device;
detecting a feature point based on a light source from an image obtained from an imaging unit and performing tracking between frames, the light source being arranged in the predetermined space and having a lighting timing controlled by a server on a basis of a time lag between the imaging unit provided in the mobile object and the server that controls the first UWB device; and
estimating a self-position and posture on a basis of a feature point of the light source, and correcting the self-position and posture on a basis of the distance measurement information.

18. A program for causing a computer to function as:
a communication unit configured to receive distance measurement information between a first ultra wide band (UWB) device arranged in a predetermined space and a second UWB device provided in a mobile object, through UWB communication via the second UWB device;
an LED feature point detection unit configured to detect a feature point based on a light source from an image obtained from an imaging unit and perform tracking between frames, the light source being arranged in the predetermined space and having a lighting timing controlled by a server on a basis of a time lag between the imaging unit provided in the mobile object and the server that controls the first UWB device; and
a self-position and posture estimation unit configured to estimate a self-position and posture on a basis of a feature point of the light source, and correct the self-position and posture on a basis of the distance measurement information.
